(19) United States
(12) Patent Application Publication
(10) Pub. No.: US 2008/0018991 A1
(43) Pub. Date: Jan. 24, 2008

(54) Glan-Thompson Type Broadband Polarizer Device for Use in the Deep Ultraviolet Spectral Range and Method of Its Manufacture

(76) Inventors: Michael Winik, Mazkeret Batya, IL (US); Shahar Gov, Rehovot (IL); Moshe Finaroy, Rehovot (IL)

Correspondence Address: BROWDY AND NEIMARK, P.L.L.C.;624 NINTH STREET, NW, SUITE 300, WASHINGTON, DC, 20001-5303, US

(21) Appl. No.: 10/591,651

(22) PCT Filed: Aug. 2, 2004
(86) PCT No.: PCT/IL04/00707

§ 371 Date: Jul. 20, 2007

(30) Foreign Application Priority Data
Mar. 4, 2004 (IL) 160724
Mar. 31, 2004 (IL) 161196

(51) Int. Cl. G02B 27/28

(52) U.S. Cl. 359/352; 359/496

(57) ABSTRACT

A broadband polarizer device of a Glan-Thompson type is described, as well as a method of manufacturing such device. Such parameters as a material of the polarizer prisms, the prisms' configuration and a glue material, are selected so as to ensure total internal reflection for the broadband input light, including DUV spectral range (from about 190 nm). The glue material is selected so as to be characterized by a dispersion profile matching that of the polarizer prisms' material for extraordinary and ordinary rays in the broadband spectral range. Different methods of manufacturing such broadband polarizer are described is disclosed.

### FIELD OF THE INVENTION

This invention relates to a polarizer device and method of its manufacture.

### BACKGROUND OF THE INVENTION

Polarizers are optical elements used to determine the direction of the electric field of an electromagnetic wave. Most radiation sources including all natural sources are unpolarized sources. If polarizer is located in the optical path of an unpolarized light beam, the polarizer output will mainly contain only one of the two linear orthogonal polarization components of the input beam, depending on the preferred axis of the polarizer. The ratio between the energy of the un-preferred polarization component and that of the preferred polarization component in the output light beam is usually valued by the polarizer's extinction ratio.

Polarizers are required in a large range of optical systems, including among others ellipsometers. Polarizers can be implemented from a variety of materials, including polymers, crystals, organic and inorganic compounds. Polarizers frequently used in optometry and photography are made of polymers. They, however, do not operate in Deep UV (DUV), which is important for example for spectrometric measurements.

Mostly used DUV-transmitting materials are in fact crystals. Polarizers are made of birefringent crystals. With a birefringent crystal, a light beam with a polarization vector parallel to the optical axis of the crystal (“Extra-Ordinary ray”) will experience a different (usually lower) index of refraction, nₑ, compared to that of a beam with a polarization vector perpendicular to the optical axis of the crystal (“Ordinary rays”), nₒ.

There are several types of polarizers based on matching two prisms made of birefringent materials. The operation of some of these polarizers, including Glan-Thompson and Glan-Taylor type polarizers, is based on the principle of total internal reflection (TIR). FIGS. 1A and 1B illustrate the configuration and operational principles of such polarizers. As shown, the polarizer is formed by two prisms P₁ and P₂ (typically of a rectangular triangle cross section) attached to each other by their tilted surfaces S₁ and S₂, respectively. In the Glan-Thompson type polarizer, the surfaces S₁ and S₂ are spaced from each other by optical glue, such as “WELD-ON 3” commercially available from IPS Corporation or NOA 61, commercially available from Norland Products Inc.

According to Snell's law of refraction, an input light beam which impinges from a first medium (prism P₁) onto an interface between the first and second media (prisms P₁ and P₂) with an angle of incidence θ₁, is refracted at the interface and enters the second medium (prism P₂) with the angle of incidence θ₂, which is given by:
n₁·sin(θ₁)=n₂·sin(θ₂) (1)
where n₁ and n₂ are the indices of refraction of the first and second media, respectively.

Total internal reflection occurs when n₁>n₂ and θ₁ is sufficiently large. Extracting sin(θ₂) from equation (1), results in:
sin(θ₂)=(n₁/n₂)·sin(θ₁) (2)

If sin(θ₁)>(n₂/n₁), than ((n₁/n₂)·sin(θ₁))>1 and there is no solution for θ₂. In this case, no light will pass the interface and 100% of the input light will be reflected back into the first medium.

Glan type polarizers use the above effect in the following way: A prism P₁ is made of a birefringent crystal, and is oriented with respect to an input light beam such that the preferred axis of the crystal (its optical axis) is parallel to the direction D₁ of propagation of the input beam. Ordinary and extraordinary rays Rₒ and Rₑ of the input beam experiences different indices of refraction nₒ and nₑ of the birefringent crystal. For a light beam impinging onto the input surface of the prism with the zero angle of incidence, none of the ordinary and extraordinary rays is refracted at the input surface of the prism. Inside the prism, these rays are incident on a tilted output surface (surface S₁) of the prism. If an angle between the tilted interface S₁ and the direction of incident beam propagation (which defines the angle of incidence θ of the input beam onto the surface S₁ and which is defined by the cut angle θ′ of the prism) is chosen such that only one of the rays (e.g., Rₑ) is reflected by total internal reflection while the other (Rₒ) passes through this interface and emerges from the prism P₁, then the required polarization effect is achieved (i.e., linearly polarized output beam Rₒ). In order to direct the output beam in the original direction D₁ of the input beam and avoid spectral dispersion, a second prism P₂ is used.

Considering n₂ is a refractive index of the medium between the two prisms (air in the Glan-Taylor type polarizer and optical glue in the Glan-Thompson polarizer), the polarization effect can be achieved when the condition sin(θ)>(n₂/nₒ) is satisfied for the ordinary ray only (assuming nₑ<nₒ. Hence, the following condition is typically taken into account when designing a polarizer:
1/nₒ<sin(θ)/n2<1/nₑ (3)
which is typically adjusted by solely varying the value of the cut angle θ′.

### SUMMARY OF THE INVENTION

There is a need in the art to facilitate polarization effect within a broad spectral range (including DUV) with a single polarizer assembly. Various applications require high transmission and high extinction ratio of the polarizer assembly over the whole spectral range at the same time.

Glan-Taylor polarizer has a limited angular field when used for broad spectral band, because the refractive index of air is constant, while the indices of refraction nₑ and nₒ of the prism depend on wavelengths of the input light (i.e., have certain dispersion profiles). As a result, the operation of this polarizer is limited by the value of angle θ′. As for Glan-Thompson polarizer, its operation depends critically on the properties of the glue between the two prisms, therefore the operation of this polarizers is limited by a specific, practically narrow, usually visual only or DUV spectral range. For example, WELD-ON 3 commercially available from IPS Corporation and NOA 61, commercially available from Norland Products Inc. provide for operating in a visual spectral range.

The present invention solves the above problem by providing a polarizer configuration generally similar to the Glan-Thompson prism polarizer or Glan-Thompson splitter (i.e., optical glue between two crystal prisms), where such parameters as a material of the polarizer prisms, the prisms' configuration (the so-called “cut angle” of the prism), and a glue material, are selected so as to ensure total internal reflection of one of the ordinary and extraordinary beam components of input light for the broadband input light, namely including DUV spectral range (from about 190 nm).

The prisms are made of a birefringent material and are configured such that the preferred axis of the prism material forms a predetermined angle (cut angle of the prism) with the tilted surface of the prism by which it is coupled to the other prism.

The glue material is selected so as to be characterized by a dispersion profile (its refraction index n_{g} as a function of wavelength) matching that of the polarizer prisms' material (crystal) for extraordinary and ordinary polarization axis (refraction indices nₑ and nₒ as functions of wavelength) in the broadband spectral range. The selected glue composition has to be stable over time when exposed to variations in environmental conditions (temperature variations, UV radiation, etc.).

An additional potential problem when designing the polarizer is associated with absorption/scattering properties of the glue. To this end, the glue layer is to be desirably thin. The minimal possible thickness of the glue layer is determined by the effective “skin-depth” inside the glue, which is defined by the refractive index of the glue and the refractive index of the polarizer prisms' material for the selected one of the ordinary or extraordinary beam component which is to be passed through (refracted by) the entire polarizer. Preferably, in order to desirably minimize the thickness of the glue layer (a thickness of a few microns, e.g., 5-10 microns) while maintaining the uniformity of the layer thickness, the present invention utilizes mixing the glue material with small solid transparent particles (beads), made for example from glass or plastic. The number of the beads in the glue layer is defined by the requirement to minimize the glue layer absorption of DUV radiation. These small beads (with the diameter of about 5-10 microns) should preferably be distributed within the surface area of the glue layer with the area concentration Cₛ not exceeding 10⁻⁶ cm⁻², and thus the volume concentration, Cᵥ, of the beads in the glue is to be lower than 10⁻⁹ cm⁻³.

Considering the polarizer prisms are α-BBO crystals, the preferred glue material is a two-part RTV Silicone transparent to electromagnetic radiation within a wide spectral range including short wavelength of about 190 nm. Such glue may be controlled volatility, low viscosity, low outgassing glue of the type CV15-2500, commercially available from NuSil Technology, USA. This glue material has a 1.41 refractive index in visual spectral range, and a 50 μm layer of the glue has about 95% transparency.

Preferably, in order to minimize the footprint of the polarizer while not affecting its operation, the side facets of the polarizer (light input and output facets) are of circular geometry or a polygon of more than four angles (e.g., eight-angle polygon).

There is thus provided according to one broad aspect of the present invention, a polarizer device of Glan-Thompson type comprising:

first and second prisms made of a birefringent material having certain dispersion profiles nₒ(λ) and nₑ(λ) for, respectively ordinary and extraordinary polarization axis and being coupled to each other by a binding material layer, wherein said binding material has a dispersion profile, n_{g}(λ), matching said dispersion profiles nₒ(λ) and nₑ(λ) so as to provide an effect of total internal reflection within a spectral range including short wavelength of about 190 nm.

According to another broad aspect of the present invention, there is provided a polarizer device of Glan-Thompson type comprising:

first and second prisms made of a birefringent material having certain dispersion profiles nₒ(λ) and nₑ(λ) for, respectively ordinary and extraordinary polarization axis and being coupled to each other by a binding material layer including a mixture of a binding material and small beads of a solid transparent material, wherein said binding material has a dispersion profile, ng(λ), matching said dispersion profiles nₒ(λ) and nₑ(λ) so as to provide an effect of total internal reflection within a spectral range including short wavelength of about 190 nm.

According to yet another broad aspect of the present invention, there is provided a polarizer device comprising:

first and second prisms made of a birefringent material having certain dispersion profiles nₒ(λ) and nₑ(λ) for, respectively ordinary and extraordinary polarization axis and being coupled to each other by a binding material layer including a mixture of a binding material and small beads of a solid transparent material, wherein said binding material has a dispersion profile, n_{g}(λ), matching said dispersion profiles nₒ(λ) and nₑ(λ) so as to provide an effect of total internal reflection within a spectral range including short wavelength of about 190 nm and wherein the beads being substantially uniformly distributed within the binding material layer with a surface area concentration, Cs, substantially not exceeding 10−6 cm⁻².

According to yet another aspect of the present invention, there is provided a polarizer device comprising:

first and second prisms coupled to each other by their tilted surfaces; and a binding material layer between said tilted surfaces of the prisms, said layer including a mixture of a binding transparent material and small beads of a solid transparent material, the binding material layer thereby having a substantially uniform thickness of about 5-10 microns.

According to yet another aspect of the present invention, there is provided a polarizer device having opposite side facets serving for, respectively, inputting and outputting light, wherein each of said side facets is either a circle or a polygon of more than four angles.

According to yet another broad aspect of the present invention there is provided a method of manufacturing a polarizer device of Glan-Thompson type comprising providing first and second prisms made of a selected birefringent material having certain dispersion profiles nₒ(λ) and nₑ(λ) for, respectively ordinary and extraordinary polarization axis, selecting a binding material having a dispersion profile, n_{g}(λ), matching said dispersion profiles nₒ(λ) and nₑ(λ) so as to provide an effect of total internal reflection within a spectral range including short wavelength of about 190 nm and attaching the tilted surfaces of the prisms to each other by a layer of said binding material.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1A and 1B show the configuration and operational principles of a conventional double-prism polarizer;

FIG. 2 illustrates a polarizer device of the present invention;

FIGS. 3A to 3C graphically illustrate the principles of the present invention for designing an α-BBO polarizer device, wherein FIG. 3A shows the total reflection angle of the prism as a function of wavelength of input light for 1.4 refractive index of a glue layer between two α-BBO crystal prisms, FIG. 3B shows the dispersion profile of the glue layer, and FIG. 3C shows the optimal conditions for the polarizer configuration;

FIG. 4 shows the minimal and maximal dispersion profiles for a glue material suitable to be used in a polarizer device with the cut angle of 30.4°, and the dispersion profile of a specific glue material available in the market;

FIG. 5 illustrates yet another principle of the invention for designing a polarizer device, showing a skin-depth in glue layer versus wavelength of input light;

FIG. 6 illustrates another example of a polarizer device of the present invention; and

FIGS. 7A-7D illustrate yet another advantageous feature of the present invention, wherein FIGS. 7A-7B show the typical shape of the convention polarizer, and FIGS. 7C-7D show that of the polarizer of the present invention aimed at minimizing the footprint of the polarizer while not affecting its operation.

### DETAILED DESCRIPTION OF THE INVENTION

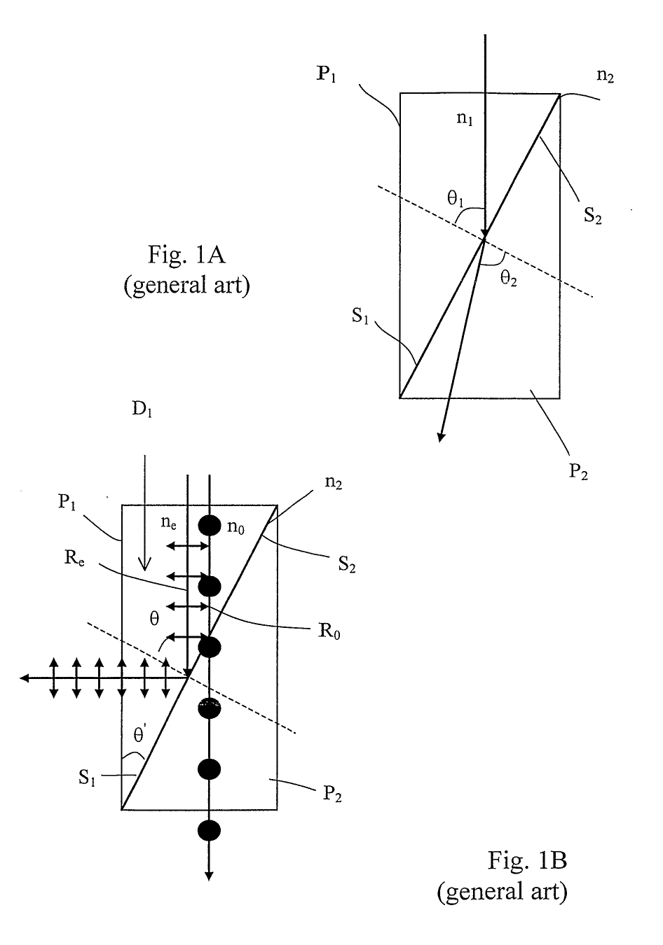

FIGS. 1A and 1B illustrate the configuration and operation principles of a conventional polarizer device of Glan-Tailor type (two prisms mechanically coupled to each other with an air gap between them) or Glan-Thomson type (two prisms glued to each other).

The present invention provides for a novel polarizer device suitable to be used for extracting either one of ordinary or extraordinary polarization component of input light or splitting thereof within a broadband spectral range of the input light, i.e., including DUV (about 190 nm) to IR (950 nm) and longer.

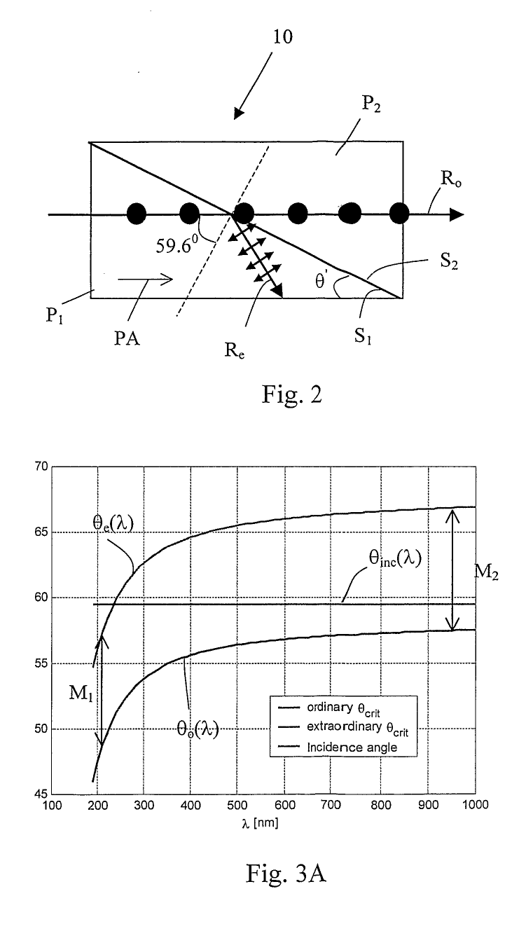

Referring to FIG. 2, there is schematically illustrated a polarizer device 10 of the present invention. The device 10 of Glan-Thomson type is formed by two prisms P₁ and P₂ attached to each other by an optical glue layer 12 between the tilted surfaces of S₁ and S₂ of the prisms P₁ and P₂, respectively. In this device, the following parameters are appropriately selected to ensure the device operation for light within the spectral range of about 190 nm-950 nm: cut angle θ′ of the prism; and the properties of the glue material layer 12.

The prisms P₁ and P₂ are made of a birefringent material that is transparent for the required broadband spectral range, and is preferably α-BBO or quartz. The prisms are configured such that the preferred axis PA of the prism material forms a predetermined angle θ′ (cut angle) with the tilted surface S₁ of the prism P₁ by which it is coupled to the other prism P₂. The glue material for the layer 12 is selected so as to be characterized by a dispersion profile n_{g}(λ) matching the dispersion profiles nₑ(λ) and nₒ(λ) of the prism material for, respectively, extraordinary and ordinary rays Rₒ and Rₑ in the required spectral range. Moreover, the glue material is selected to be stable over time when exposed to variations in environmental conditions (temperature variations, UV radiation, etc.). For α-BBO crystal prisms, the preferred glue material is a two-part RTV Silicone transparent to electromagnetic radiation ranging from 190 nm to 800 nm. Such glue may be controlled volatility, low viscosity, low outgassing glue CV15-2500, commercially available from NuSil Technology, USA (a 50 μm layer of this glue has about 95% transparency).

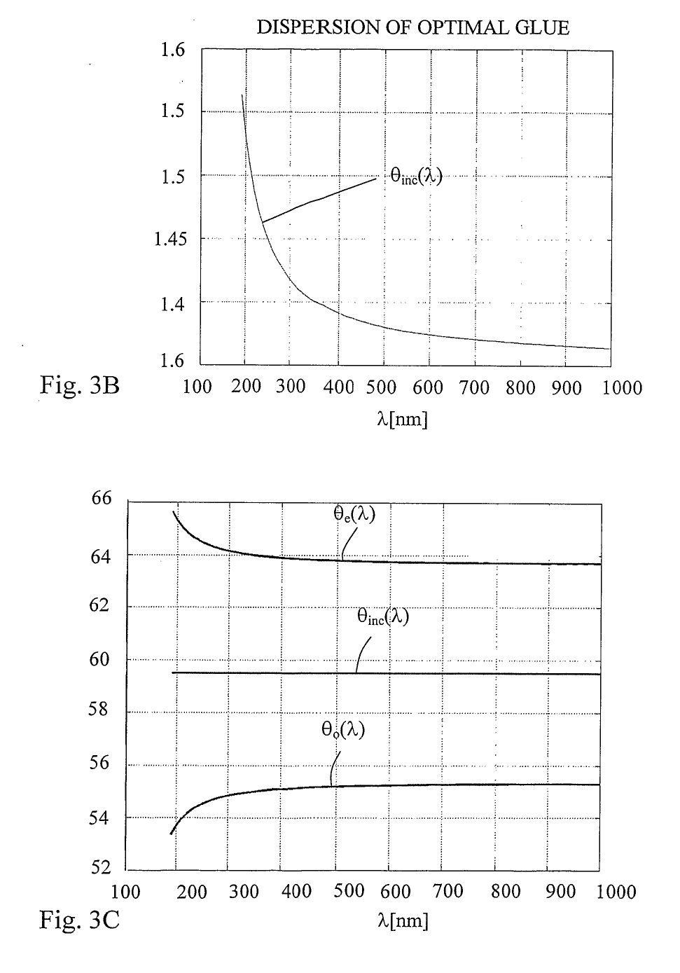

Reference is now made to FIGS. 3A-3C illustrating the principles of the present invention for designing a α-BBO polarizer device.

Let us assume that the refractive index of the glue is constant over all wavelength (i.e., the glue material has no dispersion), for example is about 1.4. FIG. 3A shows the total reflection angles θₒ and θₑ for the ordinary and extraordinary polarization components of the input beam in the prism as functions of wavelength of the input beam for 1.4 refractive index glue layer between two α-BBO crystal prisms. For the proper operation of a polarizer device, the angle of incidence θ of the input beam with respect to the tilted surface S₁ of the prism P₁ must be between the curves θₒ(λ) and θₑ(λ) of the total internal reflection for ordinary and extraordinary rays of this input beam. To this end, a finite conjugate situation is to be considered and the fact that the input beam has a certain beam divergence. In other words, the angle of incidence θ of the input beam, namely, the cut angle of the prism (considering that the prism when in use is oriented such that the beam impinges onto the prim along its optical axis) should be selected such that enough margins M₁ and M₂ are provided between the angle θ and angles θₒ or θₑ within the required spectral range for the device operation. As can be seen in FIG. 3A, a certain problem might be in a spectral range below 230 nm and also at the upper spectral range slightly above 1000 nm. For α-BBO polarizer device with 1.4 refractive index glue layer, the optimal angle of incidence θ is about 59-60° (preferably 59.6°), the cut angle being θ′=(90−θ).

While selecting glue material having an optimal dispersion profile, as shown in FIG. 3B, the cut angle of the prism, and accordingly the angle of incidence θ, would match the TIR conditions of the ordinary and extraordinary rays, θₒ(λ) or θₑ(λ), as shown in FIG. 3C.

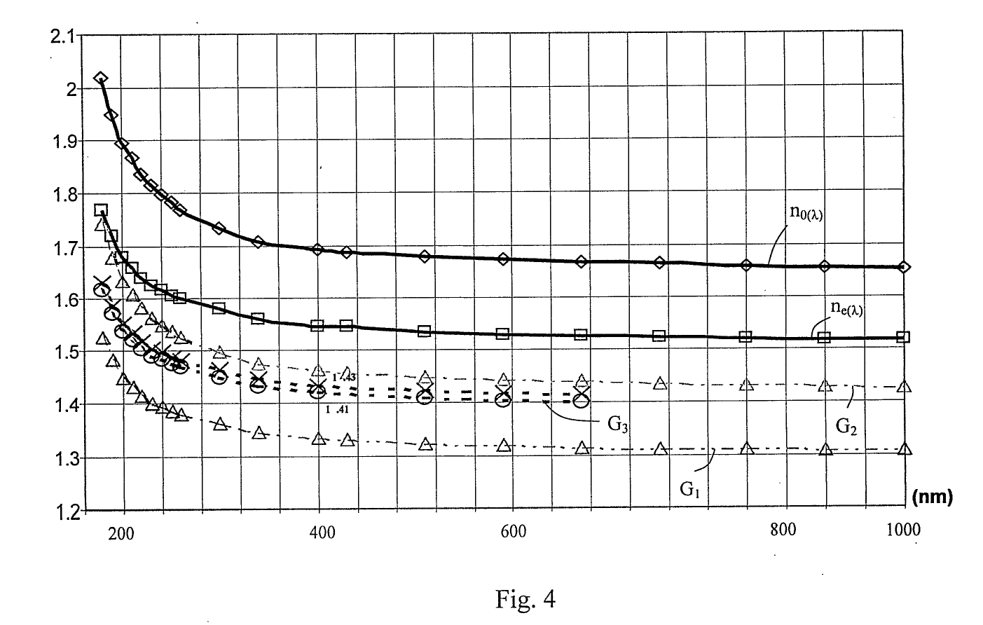

Generally speaking, the glue material should be selected such that its dispersion profiles for ordinary and extraordinary rays n^{(g)}ₒ(λ) or n^{(g)}ₑ(λ) match the dispersion profiles of the prism material, n^{(p)}ₒ(λ) or n^{(p)}ₑ(λ). FIG. 4 shows the minimal and maximal dispersion profiles G₁ (n^{(g)}ₒ(λ)) and G₂ (n^{(g)}ₑ(λ)), respectively, for a glue material suitable to be used in a polarizer device with the cut angle θ′=30.4° (θ′=90-59.6°). The inventors have found that CV15-2500, commercially available from NuSil Technology, USA has the dispersion profile (graph G₃) satisfying this requirement.

Furthermore, the glue layer should preferably be sufficiently thin (a few microns, e.g., 5-10 microns) to avoid undesirable light absorption in the glue (which is essential for DUV spectral range). The minimal possible thickness of the glue layer is determined by the effective “skin-depth” inside the glue, which is defined by the refractive index of the glue and the refractive index of the polarizer prisms' material for the selected one of the ordinary or extraordinary beam component which is to be passed through (refracted by) the entire polarizer. In other words, the glue layer should not be too thin to avoid “tunneling”.

With the refractive index of ordinary ray for α-BBO being n_{ord} and that of the glue being n_{glue}, and the incidence angle θ=59.5°, the rate of decay of light inside the glue can be estimated as follows:

The lateral component of the k-vector at the crystal (which must also be inside the glue) is:
kₓ=n_{ord}k₀ sin θ_{inc}

The total k-vector length inside the glue is n_{glue}k₀, therefore the component of the vector inside the glue that is normal to the plane must be:

$$\begin{matrix}{k}_{z , glue} = {k}_{0} \sqrt{{n}_{glue}^{2} - {n}_{ord}^{2} {sin}^{2} {θ}_{inc}} \\ = - {jk}_{0} \sqrt{{n}_{ord}^{2} {sin}^{2} {θ}_{inc} - {n}_{glue}^{2}}\end{matrix}$$

Since the field inside the glue depends on z (axis normal to the plane of beam propagation) according to
exp(jk_{z}z)=exp(−k₀z\sqrt{n_{ord}² sin² θ_{inc}−n_{glue}²})=exp(−z/δ)
the effective “skin-depth” δ inside the glue is:

$$δ = \frac{1}{{k}_{0} \sqrt{{n}_{ord}^{2} {sin}^{2} {θ}_{inc} - {n}_{glue}^{2}}}$$

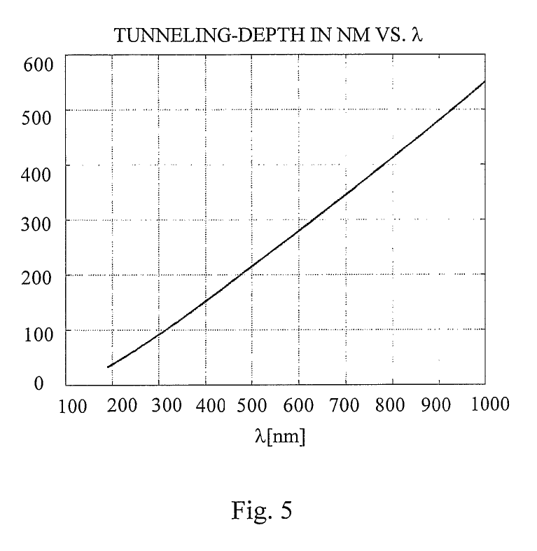

FIG. 5 illustrates a plot of this skin-depth versus wavelength: For a proper operation, actual glue thickness should be about 10 times this value δ, giving for entire range of wavelengths up to 950 nm a minimum thickness of about 6 microns. This parameter depends on the maximal wavelength of the required spectral range.

The glue layer should thus be desirable thin and with the uniform thickness along the layer.

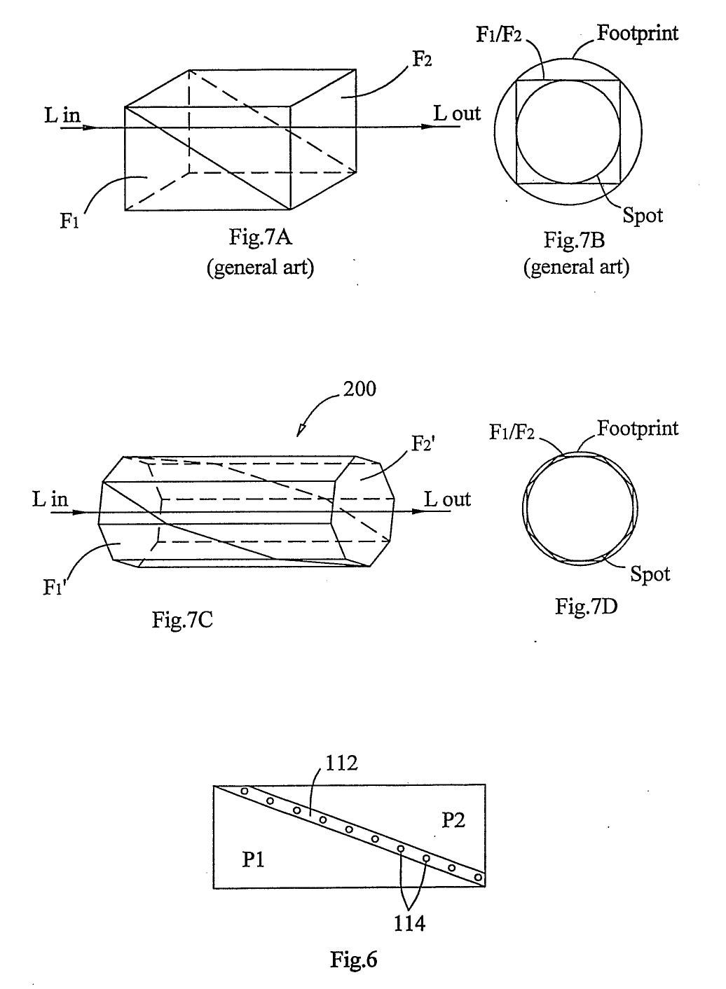

FIG. 6 exemplifies a polarizer device 100 in which the uniformly thin glue layer 112 is obtained by mixing a glue material (selected as described above) with small solid transparent particles (beads) 114, made for example from glass or plastic. The concentration of the beads 114 in the glue layer 112 is defined by the requirement to minimize the glue layer absorption of DUV radiation. The small beads (with the diameter of about 5-10 microns) are preferably distributed within the surface area of the glue layer with the area concentration Cₛ not exceeding 10⁻⁶ cm⁻², and thus the volume concentration, Cᵥ, of the beads in the glue is lower than 10⁻⁹ cm⁻³. Such concentration enables negligible effect of particles on the polarizer performance.

It is often the case that an optical system should be of as small footprint as possible (for example in integrated metrology/inspection tools). The present invention provides for solving this problem by designing a polarizer with its side facets (input and output facets) as a circle or polygon of more than four angles, rather than a typically used rectangle. This is illustrated in FIGS. 7A-7D.

FIG. 7A shows a typical shape of a polarizer device having rectangular input and output facets F₁ and F₂. As shown in FIG. 7B, the dimensions of this facet F₁ (and F₂) define the maximal spot size diameter of the output beam and the minimal footprint of this polarizer.

FIGS. 7C and 7D illustrate a polarizer device 200 of the present invention. The device 200 has side facets F′₁ and F′₂ in the form of a polygon with more than 4 angles—eight-angle polygon in the present example. It should be understood that the best case would be a circular geometry of the side facets, but this is more difficult to implement. As can be seen from FIG. 7D, this polarizer is characterized by smaller footprint for the same spot size of the output beam, as compare to that of FIGS. 7A-7B.

Those skilled in the art will readily appreciate that various modifications and changes can be applied to the embodiments of the invention as hereinbefore exemplified without departing from its scope defined in and by the appended claims.

1. A polarizer device of Glan-Thompson type comprising first and second prisms made of a birefringent material having certain dispersion profilsen, (k) andn, (/%) for, respectively ordinary and extraordinary polarization axis and being coupled to each other by a binding material layer, wherein said binding material has a dispersion profile, ng( ), matching said dispersion profilesn, (k) and rie(X) so as to provide an effect of total internal reflection within a spectral range including short wavelength of about 190 nm.

2. The device of claim 1, wherein said prisms made of A-BOBO crystals.

3. The device of claim 1, wherein said first and second prisms have a cut angle 0′of about 31.

4. The device of claim 1, wherein said binding material is RTV silicone.

5. The device of claim 1, wherein said binding material is a two-part material.

6. The device of claim 1, wherein said binding material has controlled volatility.

7. The device of claim 1, wherein said binding material has low viscosity.

8. The device of claim 1, wherein said binding material is CV15-2500 optical glue, commercially available from NuSil Technology, USA.

9. The device of claim 1, wherein said binding material layer has a thickness of a few microns.

10. The device of claim 1, wherein said binding material layer includes a mixture of an optical glue material with small beads of solid transparent material.

11. The device of claim 10, wherein said beads are uniformly distributed within the glue material with a surface area concentration of the beads substantially not exceeding 10−′cm−′.

12. The device of claim 1, wherein each of the prisms' facets defining side facets of the device for inputting and outputting light has a circular geometry.

13. The device of claim 1, wherein each of the prisms' facets defining side facets of the device for inputting and outputting light is a polygon of more than four angles.

14. The device of claim 1, wherein each of the prisms' facets defining side facets of the device for inputting and outputting light is an eight-angle polygon.

15. A polarizer device of Glan-Thompson type comprising first and second prisms made of a birefringent material having certain dispersion profiles n,, (k) and ne (X) for, respectively ordinary and extraordinary polarization axis and being coupled to each other by a binding material layer including a mixture of a binding material and small beads of a solid transparent material, wherein said binding material has a dispersion profile, ng (X), matching said dispersion profiles no (X) and ne (X) so as to provide an effect of total internal reflection within a spectral range including short wavelength of about 190 nm.

16. A polarizer device of Glan-Thompson type comprising first and second prisms made of a birefringent material having certain dispersion profiles no (X) and ne (X) for, respectively ordinary and extraordinary polarization axis and being coupled to each other by a binding material layer including a mixture of a binding material and small beads of a solid transparent material, wherein said binding material has a dispersion profile, ng(X), matching said dispersion profilesno (7) andne (k) so as to provide an effect of total internal reflection within a spectral range including short wavelength of about 190 nm and wherein the beads being substantially uniformly distributed within the binding material layer with a surface area concentration, C, substantially not exceeding 10˜6 cm˜2.

17. A polarizer device comprising first and second prisms coupled to each other by their tilted surfaces; and a binding material layer between said tilted surfaces of the prisms, said layer including a mixture of a binding transparent material and small beads of a solid transparent material, the binding material layer thereby having a substantially uniform thickness of about 5-10 microns. A polarizer device having opposite side facets serving for, respectively, inputting and outputting light, wherein each of said side facets is either a circle or a polygon of more than four angles.

18. A method of manufacturing a polarizer device of Glan-Thompson type comprising providing first and second prisms made of a selected birefringent material having certain dispersion profilesr, (X) and ne(X) for, respectively ordinary and extraordinary polarization axis, selecting a binding material having a dispersion profile,ng(,), matching said dispersion profilesno (7) andne (k) so as to provide an effect of total internal reflection within a spectral range including short wavelength of about 190 nm and attaching the tilted surfaces of the prisms to each other by a layer of said binding material.

19. A method of manufacturing a polarizer device of Glan-Thompson type comprising providing first and second prisms coupled to each other at their tilted surfaces by a binding material layer, which includes a mixture of a binding transparent material and small beads of a solid transparent material, the binding material layer thereby having a substantially uniform thickness of about 5-10 microns.

20. A method of manufacturing a polarizer device of Glan-Thompson type comprising providing first and second prisms coupled to each other at their tilted surfaces by a binding material layer, which includes a mixture of a binding transparent material and small beads of a solid transparent material, the binding material layer thereby having a substantially uniform thickness of about 5-10 microns.

21. The method for manufacturing a polarizer device of Glan-Thompson type of any of the preceding method claims comprising configuring opposite side facets serving for, respectively, inputting and outputting light, to be either a circle or a polygon of more than four angles, thereby minimizing a footprint of the polarizer device.
